(19) United States
(12) Patent Application Publication
(10) Pub. No.: US 2025/0232273 A1
(43) Pub. Date: Jul. 17, 2025

(54) MONEY HANDLING SYSTEM AND MONEY HANDLING EQUIPMENT

(71) Applicant: Glory Ltd., Himeji-shi (JP)

(72) Inventor: Shinichi KAYAMA, Himeji-shi (JP)

(73) Assignee: Glory Ltd., Himeji-shi (JP)

(21) Appl. No.: 19/012,969

(22) Filed: Jan. 8, 2025

(30) Foreign Application Priority Data
Jan. 16, 2024 (JP) 2024-004664

(51) Int. Cl. G06Q 20/10; B65H 43/00; G07D 11/13; G07D 11/14; G07D 11/60

(52) U.S. Cl. CPC G06Q 20/1085; B65H 43/00; G07D 11/13; G07D 11/14; G07D 11/60; B65H 2701/1912; G07D 2211/00

(57) ABSTRACT

A money handling system includes a money handling device operated by a customer and a reception device which accepts input of information about a monetary transaction of the customer. The money handling device includes first control circuitry and the reception device includes second control circuitry. The second control circuitry is configured to output transaction information in response to accepting the input. The first control circuitry is configured to execute, in response to obtaining the transaction information output by the reception device, a transaction preparation process to prepare money for the monetary transaction. The first control circuitry is configured to execute, in response to accepting an operation by the customer, a transaction process based on the transaction information by using the money prepared in the transaction preparation process.

### CROSS-REFERENCE TO RELATED APPLICATION

The present application is a continuation of, and claims priority to, Japanese Patent Application No. 2024-004664, filed in Japan on Jan. 16, 2024, the contents of which is hereby incorporated by reference in its entirety.

### TECHNICAL FIELD

This disclosure relates to a money handling system and a money handling device.

### BACKGROUND

Conventionally, a money processing system is equipped with a reception device and a money processing device. The money handling device is controlled based on transactions accepted by the reception device.

### SUMMARY

In an exemplary implementation of the present disclosure, a money handling system includes a money handling device operated by a customer and a reception device which accepts input of information about a monetary transaction of the customer. The money handling device includes first control circuitry and the reception device includes second control circuitry. The second control circuitry is configured to output transaction information in response to accepting the input. The first control circuitry is configured to execute, in response to obtaining the transaction information output by the reception device, a transaction preparation process to prepare money for the monetary transaction. The first control circuitry is configured to execute, in response to accepting an operation by the customer, a transaction process based on the transaction information by using the money prepared in the transaction preparation process.

### BRIEF DESCRIPTION OF THE DRAWINGS

FIG. 1 illustrates a schematic diagram of an exemplary financial store.

FIG. 2 illustrates a money handling device.

FIG. 3 illustrates an inside of a banknote transaction device in a money handling system.

FIG. 4 illustrates an inside of a coin transaction device in the money handling system.

FIG. 5 illustrates a control structure of the money handling system.

FIG. 6 illustrates a flow of customer actions and a flow of automated processing by the money handling system.

FIG. 7 illustrates a transaction device of the money handling system.

FIG. 8 illustrates a flow of money when a withdrawal preparation process is executed at a banknote transaction device.

FIG. 9 illustrates a flow of money when a first withdrawal process is executed at a banknote transaction device.

FIG. 10 illustrates a flow of money when a deposit preparation process is executed at a banknote transaction device.

FIG. 11 illustrates a flow of money when a deposit process is executed at a banknote transaction device.

FIG. 12 illustrates a flow of money when a deposit process is executed at a banknote transaction device.

FIG. 13 illustrates a flow of money when a second withdrawal process is executed by the banknote transaction device.

FIG. 14 illustrates another example of a financial store.

### DETAILED DESCRIPTION

Since money handling machines often handle larger amounts of money than ordinary automated teller machines (ATMs), processing of money transactions may be time-consuming. If customers are unfamiliar with an operation of the money handling device, a time from the start to the end of the transaction may become longer, which may hinder an efficiency of the business. The inventors of the present disclosure have developed the technology of the present disclosure to reduce customer waiting time and to enable customers to proceed smoothly with transactions at a money handling device.

In an exemplary configuration of a money handling system according to the present disclosure, the money handling system includes a money handling device equipped with a first control unit and operated by a customer, and a reception device equipped with a second control unit and accepting input of the contents of a money transaction from the customer, wherein the second control unit of the reception device outputs transaction information indicating the contents of the money transaction in response to receiving the input, and wherein the first control unit of the money handling device performs transaction preparation processing for the money transaction in response to receiving the input from the customer and acquiring the transaction information output by the reception device. The first control unit of the money handling device, in response to obtaining the transaction information output by the reception device, performs a transaction preparation process to prepare money for the money transaction, and, in response to receiving an operation from the customer, uses the money prepared in the transaction preparation process to prepare the money for the transaction based on the transaction information. The transaction preparation process is performed based on the transaction information in response to the receipt of the operation from the customer.

In the money handling system of the present disclosure, the reception device is a terminal device operated by the teller.

In the money handling system of the present disclosure, the reception device may be a terminal device operated by the customer.

In an exemplary configuration of a money handling system according to the present disclosure, the money handling device is provided with a storage section for storing money, a withdrawal slot for customers to receive the money, and a holding section for temporarily storing the money, and that the first control unit of the money handling device performs, as the transaction preparation process, a withdrawal preparation process to transfer the money from the storage section to the holding section. The first control unit of the money handling device performs the withdrawal preparation process to transfer the money from the storage section to the holding section as part of the transaction preparation process.

In an exemplary configuration of a money handling system according to the present disclosure, the second control unit of the reception device is configured to output first person information identifying the customer together with the transaction information, the second person information identifying a person operating the money handling device is obtained by a person identification unit, and the second person information is matched with the first person information. The first control unit of the money handling device is configured to execute the first withdrawal process when the matching unit determines that the first person information and the second person information match, and to execute the first withdrawal process when the matching unit determines that the first person information and the second person information match, and to execute the second withdrawal process when the first person information and the second person information match. If the matching section determines that the first person information and the second person information do not match, the first withdrawal processing may not be performed.

In an exemplary configuration of a money handling system according to the present disclosure, the money handling device is provided with a slot for a customer to insert the money, and that the first control unit of the money handling device is configured to execute a deposit preparation process in response to the money being inserted into the slot after the withdrawal preparation process is executed and before the first withdrawal process is executed. The first control unit of the money handling system is configured to execute a deposit preparation process to transfer the money stored in the holding section to the storage section in response to the money being fed into the input port after the withdrawal preparation process is executed and before the first withdrawal process is executed.

In an exemplary configuration of a money handling system according to the present disclosure, the first control unit of the money handling device is configured to perform, in response to the matching unit determining that the first person information and the second person information do not match and the money handling device accepting a withdrawal operation different from the money transaction, a second withdrawal process by which the money is transferred from the storage unit and the second withdrawal process is configured to transfer the money from the storage section to the withdrawal port without passing through the holding section.

In an exemplary configuration of a money handling system according to the present disclosure, the money handling system includes a plurality of the money handling devices and a reporting unit that identifies and reports the money handling device that acquired the transaction information.

In an exemplary configuration of a money handling system according to the present disclosure, a money handling device that is configured to communicate with a reception device that accepts a customer's input of the contents of a money transaction, has a control unit, and is operated by the customer. The control unit executes a transaction preparation process to prepare money for the monetary transaction in response to acquiring transaction information indicating the contents of the monetary transaction output by the reception device, and executes transaction processing based on the transaction information using the money prepared in the transaction preparation process in response to receiving an operation from the customer.

In an exemplary configuration of a money handling system according to the present disclosure, the control unit executes the transaction processing when the first person information identifying the customer and the second person information identifying the person operating the money handling system match, and does not execute the transaction processing when the first person information and the second person information do not match. The transaction processing is performed when the first person information and the second person information that identifies the customer are matched.

According to an exemplary configuration of a money handling system according to the present disclosure, customers may proceed smoothly with transactions at the money handling device.

The following is a description of the financial transaction system of the present disclosure based on the drawings. The present disclosure is not limited to the following embodiments, and various variations are possible within the scope that does not depart from the gist thereof.

### Outline of the Financial Institution's Branches

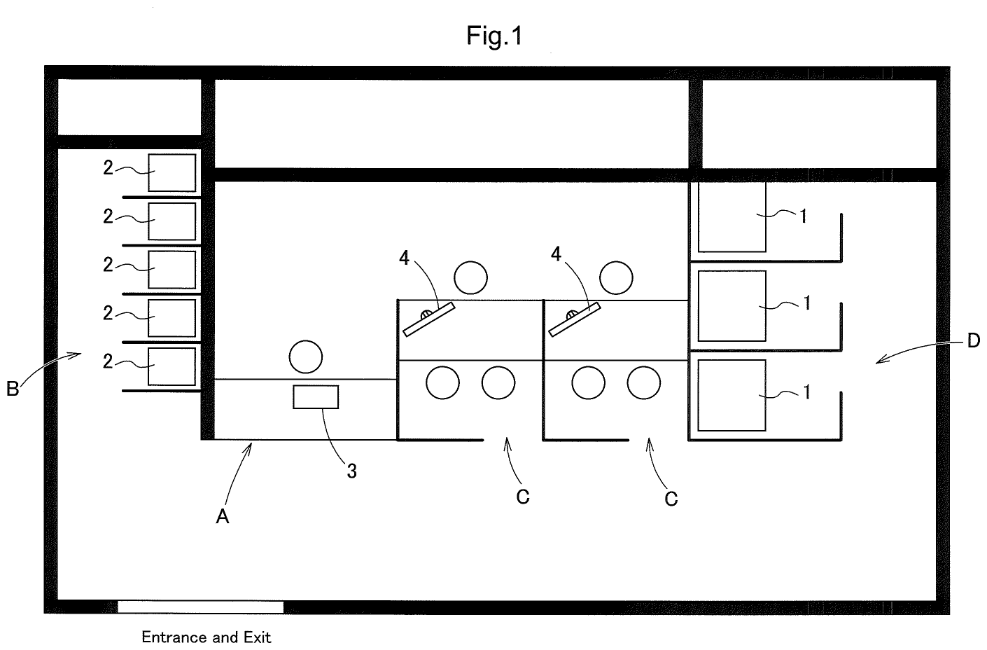

This section describes the financial transaction system in this disclosure. FIG. 1 shows an example of a financial outlet, such as a bank branch or sub-branch. The bank illustrated in FIG. 1 has a teller window A, an automated transaction booth B, a consultation booth C, and a self-deposit/withdrawal booth D, to serve customers.

Tellers (staff) in charge of processing account transactions are stationed at counter A. A reception device 3 is located at counter A.

Reception device 3 is a terminal device operated by a teller. The reception device 3 may be connected to an account server via an intra-bank network such as a wide area network (WAN) to enable data communication. In this case, the reception device 3 also serves as a terminal for managing the customer's account. Account servers are located, for example, at remote head offices or data centers, and collectively manage information related to account processing.

Several automated teller machines 2 are located in automated transaction booth B. Automated teller machines 2 are used by individual customers to deposit cash into or withdraw cash from deposit accounts. The automated teller machine 2 is connected via the bank's internal network to enable data communication with the account server. When cash deposits and withdrawals are made at the automated teller machine 2, the account updating process is also performed automatically. In addition to the two automatic teller machines, automatic money changers and automatic tax and public money collection machines could be installed.

Consultation booth C is a space where, for example, customers can consult on financial investments, inheritances, loans, etc. The customer-side consultation terminal 4 and other terminals of the remote dialogue system are located in the consultation booth C.

Money handling device 1 is a money processor located in the self-deposit/withdrawal booth D. In addition to transactions that can be processed by the automated teller machine 2, the money handling device 1 can also perform large cash transactions (deposits, withdrawals, currency exchange, etc.) that cannot be processed by the automated teller machine 2, for example.

The money handling device 1 identifies and counts bills and coins, classifies them by type, and stores them inside. In addition, the money handling device 1 internally stores a predetermined number of banded bills for each type of bill (e.g., every 100 bills) and a predetermined number of packaged coins for each type of coin (e.g., every 50 coins). A wrapped coin is a coin of the same type wrapped in a wrapping medium such as paper or film, so-called rolled coins. Therefore, the money handling device 1 is capable of processing deposits, withdrawals, and exchanges of large amounts of banknotes and coins.

### Configuration of the Money Handling System

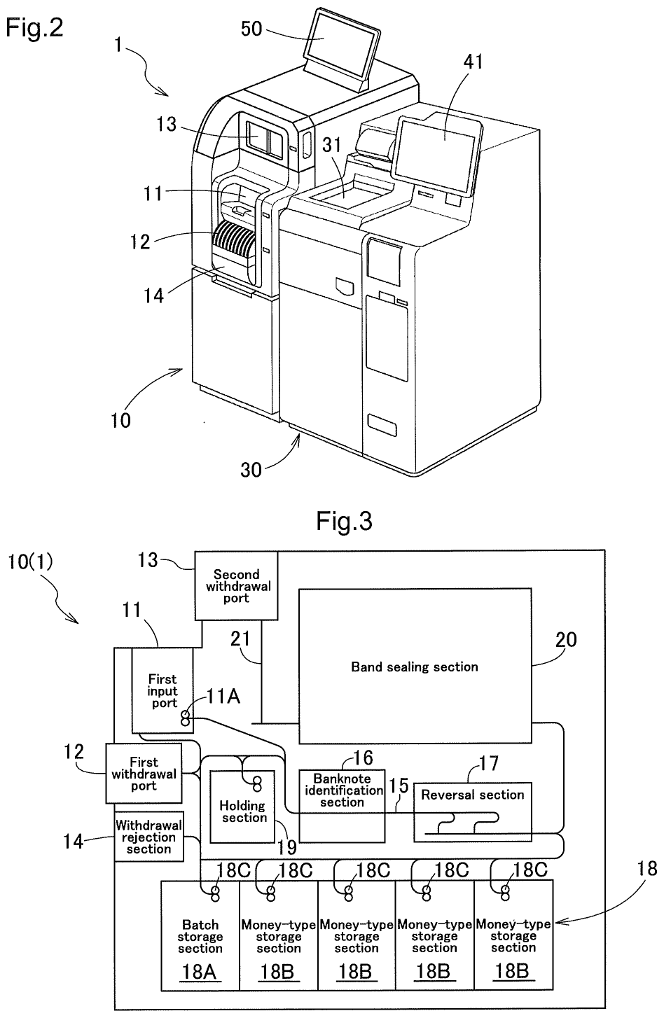

FIG. 2 shows the money handling device 1. The money handling device 1 is equipped with a banknote transaction device 10, a coin transaction device 30, and a customer service monitor 50. The banknote transaction devices 10 and the coin transaction devices 30 may be adjacent to each other.

The banknote transaction device 10 is capable of processing banknote deposits and withdrawals. The banknote transaction device 10 identifies and counts banknotes, classifies them according to type, and then produces a banded banknote for each predetermined number of bills (e.g., every 100 notes) or classifies banknotes by predetermined number of bills.

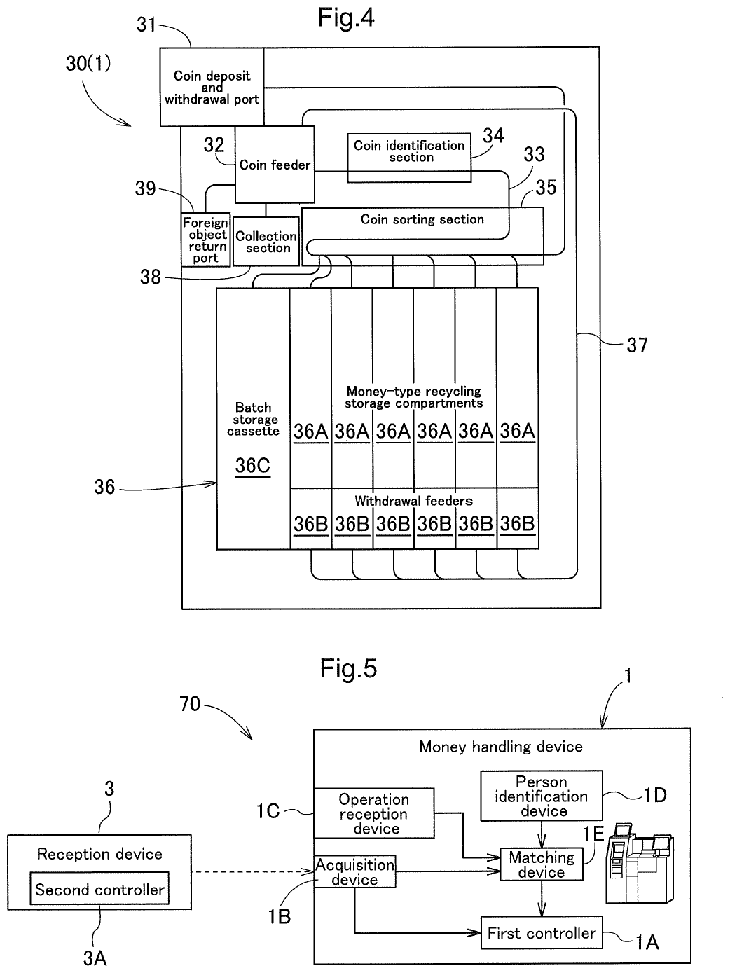

The coin transaction device 30 is capable of processing coin deposits and withdrawals. The coin deposit/withdrawal process includes, for example, transporting coins from the deposit slot and storing them in storage section 36 (see FIG. 4), and dispensing coins stored in storage section 36 to the withdrawal slot. The coin transaction device 30 identifies and counts coins, classifies them by type, and then prepares packaged coins for each predetermined number of coins (e.g., every 50 coins) or classifies coins by predetermined number of coins. A wrapped coin is a coin of the same type wrapped in a wrapping medium such as paper or film, so-called rolled coins.

The operation panel 41 is a monitor that can be operated manually, for example, by a touch panel, and is located on top of the housing of the coin transaction device 30. Users can operate the operation panel 41 to deposit and withdraw banknotes and coins. At this time, the user can pull out the banded banknote or wrapped coin from the money handling device 1 and obtain it by operating the control panel 41. In addition, the monitor of operation panel 41 displays information on the status of banknotes and coins stored in the money handling device 1. Furthermore, operation panel 41 displays a warning screen when a user makes a mistake. In addition, when an alarm occurs at the money handling device 1, operation panel 41 displays a guidance screen showing the procedure for alarm cancellation operations.

The customer service monitor 50 shows, for example, attendants and other store personnel. For example, if a user has trouble operating the money handling device 1, the face of the person in charge, etc., is projected on the customer service monitor 50, and the person in charge can ask the user about the situation or consult with the user.

### Configuration of Banknote Processing Equipment

FIG. 3 is a schematic diagram of the internal structure of the banknote transaction device 10. In FIG. 3, the left side of the paper is the front side of the banknote transaction device 10.

The banknote transaction device 10 is equipped with a first input port 11, a first withdrawal port 12, a second withdrawal port 13, and a withdrawal rejection section 14.

The first input port 11 is located at the top of the front of the enclosure in the banknote transaction device 10. Users can insert banknotes inside the first input port 11 during the deposit procedure. The first input port 11 can hold multiple banknotes in an accumulated state. Banknotes of various denominations can be fed into the first input port 11. The first input port 11 rolls out the banknotes it holds, one by one, by means of the roller 11A, into the inside of the banknote transaction device 10.

The first withdrawal port 12 is located below the first input port 11. A shutter that can be opened and closed is provided at the first withdrawal port 12. When a user performs the withdrawal procedure and the banknotes accumulate at the withdrawal port 12, the user can manually remove the banknotes from the first withdrawal port 12. In cases such as when an abnormality is detected in a banknote that a user has fed into the first input port 11 in the deposit procedure, the banknote that is detected as abnormal (rejected banknote) is transferred to the first withdrawal port 12. Again, the user can manually collect the returned rejected banknote from the first withdrawal port 12.

The second withdrawal port 13 is located above the first input port 11. A shutter that can be opened and closed is provided at the second withdrawal port 13. Once the user has completed the withdrawal procedure and the strip banknote is transported to the second withdrawal port 13, the user can manually collect the strip banknote from the second withdrawal port 13.

The withdrawal rejection section 14 is located below the first withdrawal port 12. When a user performs withdrawal procedures, banknotes that are determined not to be used for withdrawal (reject banknotes) are accumulated in the withdrawal rejection section 14 while the banknotes are being transported to the withdrawal port 12. The enclosure of the banknote transaction device 10 is equipped with a cover for the withdrawal rejection section 14. The cover is normally locked. For example, an attendant can collect rejected banknotes accumulated in the withdrawal rejection section 14 by unlocking and opening the cover.

As shown in FIG. 3, the enclosure of the banknote transaction device 10 is equipped with a first transport section 15, a banknote identification section 16, a reversal section 17, a storage section 18, a holding section 19, a band sealing section 20, and a second transport section 21.

The first transport section 15 has a transport path located inside the housing in the banknote transaction device 10. A number of transport rollers may be arranged along the transport path. The first transport section 15 transports banknotes one at a time along the transport path at predetermined intervals. The banknote identification section 16 and the reversal section 17 are located in the middle of the transport path. At the downstream portion of the transport path from the reversal section 17, the transport path splits into a storage section 18 and a band sealing section 20.

The banknote identification section 16 identifies the denomination, authenticity, front and back, orientation, fit/unfit, old/new, serial number, transport status, etc., of banknotes transported along the transport path. The serial number is a unique number, etc., attached to the banknote.

The reversal section 17 includes a switchback mechanism and a spiral mechanism to align the front and back of the banknote, the orientation of the transport width, and the orientation of the top and bottom.

The storage section 18 is located downstream of the reversal section 17 in the banknote transport direction and at the bottom of the enclosure of the banknote transaction device 10. The storage section 18 is equipped with a batch storage section 18A and four money-type storage sections 18B.

Batch storage section 18A stores banknotes in mixed denominations. For example, old bills with low market circulation and bills that are soiled or damaged are stacked in the batch storage section 18A. Damaged banknotes include, for example, banknotes that are on the verge of being torn, or banknotes that have been torn and pasted together.

In each of the four money-type storage sections 18B, for example, banknotes classified by money type are stacked and stored. For example, an authorized staff member can set the types of banknotes to be collected in each of the money-type storage sections 18B.

If the identification result of the banknote identification section 16 is normal, the banknotes transported from the first input port 11 during the deposit process are selectively fed into either the batch storage section 18A or the four money-type storage sections 18B. On the other hand, if the identification result of the banknote identification section 16 is abnormal, the banknote (reject banknote) is transported to the first withdrawal port 12 and returned to the user.

A batch storage section 18A and a withdrawal section 18C are provided at the top of each of the money-type storage sections 18B. The withdrawal section 18C is configured to allow banknotes stacked in the storage section 18 to be unloaded one at a time and fed to the first transport section 15.

The holding section 19 stores banknotes to be temporarily evacuated from the first transport section 15. For example, the holding section 19 is used to rearrange banknotes stacked in the batch storage section 18A according to predetermined criteria. The holding section 19 temporarily stores deposit bills fed into the first input port 11 or withdrawal bills taken out of the money-type storage section 18B.

The portion of the transport path of the first transport section 15 that is downstream from the holding section 19 merges with the conveyance path to the banknote identification section 16. Therefore, the transport path of the first transport section 15 circulates in the following order: the banknote identification section 16, the reversal section 17, the portion adjacent above the storage section 18, the branch to the withdrawal rejection section 14, the branch to the first withdrawal port 12, the branch to the first input port 11, the branch to the holding section 19, and the confluence with the transport path to the banknote identification section 16 The following is the order in which the sections are circumnavigated.

Branch pawls may be located in the transport path of the first transport section 15 that switch the direction of banknote transport at the junctions between the storage section 18 and the band sealing section 20, to the batch storage section 18A, to the money-type storage section 18B, to the first withdrawal port 12, to the withdrawal rejection section 14, to the first input port 11, to the holding section 19, and to the other sections. The branching jaws are provided to switch the direction of banknote transport at the branching points to the first withdrawal port 12, the branching point to the withdrawal rejection section 14, the branching point to the first input port 11, and the branching point to the holding section 19. The controller of the banknote transaction device 10 moves these branch pawls according to the purpose of the process.

As described below with respect to the details, in this form of banknote transaction device 10, the first transport section 15 includes a transport path to the first input port 11. The transport path to the first input port 11 is located on the lower side of the transport direction than the branch to the batch storage section 18A and the money-type storage section 18B in the storage section 18, and on the upper side of the transport direction than the confluence with the transport path to the banknote identification section 16. For example, if a transport error is detected in a banknote being transported through the first transport section 15, the banknote is returned to the first input port 11 via the transport path to the first input port 11.

When withdrawing unsealed banknotes (so-called loose banknotes), the banknotes are fed to the first transport section 15 by the withdrawal section 18C in the money-type storage section 18B, and pass through the banknote identification section 16 and the reversal section 17. At this time, the banknote identification section 16 identifies whether the banknote is in good condition or not. If the banknote is not in good condition, the banknote is transported to the withdrawal rejection section 14. If the banknote is in good condition, the banknote is transported to the first withdrawal port 12.

The band sealing section 20 is located above the reversal section 17. The band sealing section 20 may, for example, perform strip sealing by wrapping the strip around the outer circumference of a bundle of banknotes, or by inserting the bundle of banknotes into a loop formed by the strip.

In the band sealing section 20, pre-banded banknotes and banded banknotes that have already been banded can be stocked. For example, when an attendant specifies the banknote striping process at operation panel 41 and feeds a bundle of banknotes into the first input port 11, the banknotes are transported to the band sealing section 20 through the banknote identification section 16 and the reversal section 17, are strip-sealed, and are stocked in the band sealing section 20. At this time, the banknote identification section 16 identifies whether or not the banknote has an abnormality. If the banknote is in good condition, the banknote is transported to the band sealing section 20. If there is an abnormality in the banknote, the banknote is transported to the first withdrawal port 12 and returned to the attendant.

A second transport section 21 is adjacent to the band sealing section 20. The second transport section 21 transports the banded banknotes that have been banded by the band sealing section 20 to the second withdrawal port 13. In other words, when a withdrawal of a strip-sealed banknote is processed, the strip-sealed banknote stocked in the band sealing section 20 is transported to the second withdrawal port 13 via the second transport section 21.

When the stock of banded banknotes becomes low, a controller of the banknote transaction device 10 may be configured to automatically transport the banknotes to be banded from the money-type storage section 18B to the band sealing section 20 via the first transport section 15 to replenish the stock of banded banknotes.

### Configuration of Coin Processing Equipment

FIG. 4 illustrates an example of a coin transaction device 30. The coin transaction device 30 is equipped with a coin deposit and withdrawal port 31, a coin feeder 32, a deposit transport path 33, a coin identification section 34, a coin sorting section 35, a storage section 36, a withdrawal transport path 37, a collection section 38, and a foreign object return port 39. A coin identification section 34 is located in the middle of the deposit transport path 33.

Coin deposit and withdrawal port 31 accepts coins from the outside. A shutter that can be opened and closed is provided at the coin deposit and withdrawal port 31. Coins containing various denominations are fed into the coin deposit and withdrawal port 31.

The coin feeder 32 feeds coins one at a time from the coin deposit and withdrawal port 31. The coin identification section 34 identifies the coin type, authenticity, fit/unfit, old/new, etc., of the coins being transported. Coins identified by the coin identification section 34 are transported to the coin sorting section 35. If a foreign object is mixed in with the coin deposit and withdrawal port 31, the coin feeder 32 detects the foreign object. The foreign material is then transferred to the foreign object return port 39. Users, attendants, and others can manually collect foreign objects and other materials transported to the foreign object return port 39.

Coin sorting section 35 sorts coins based on identification results. The coin sorting section 35 returns coins identified as abnormal by the coin identification section 34, i.e., reject coins, to the coin deposit and withdrawal port 31. Coins identified as normal by the coin identification section 34 are held in the coin sorting section 35 until the deposit process is finalized.

If the abort operation is performed before the deposit process is finalized, the coins pending in the coin sorting section 35 are returned to the coin deposit and withdrawal port 31. The user can then remove coins from the coin deposit and withdrawal port 31.

Once the deposit process is finalized, the coins pending in the coin sorting section 35 are sent to the storage section 36. The storage section 36 is equipped with multiple money-type recycling storage compartments 36A and one batch storage cassette 36C. Coins are sorted by type into each of the multiple money-type recycling compartments 36A.

Each of the money-type recycling storage compartments 36A is equipped with withdrawal feeders 36B for withdrawal. The withdrawal feeder 36B advances coins one at a time from the money-type recycling storage compartments 36A by money type. Each of the withdrawal feeders 36B is connected to the withdrawal transport path 37.

When a withdrawal process is performed, coins are ejected from the money-type recycling storage compartments 36A and transported to the coin feeder 32 via the withdrawal transport path 37. The coins are further transported to the coin deposit and withdrawal port 31 via the coin identification section 34 and the coin sorting section 35. The user can then remove coins from the coin deposit and withdrawal port 31.

Withdrawal transport path 37 is also connected to transport sections for wrapped coins (bars) and shooters for bags of coins, for example. For this purpose, the coins stored in the money-type recycling storage compartments 36A by each money type may be bagged in coin bags or packaged as wrapped coins.

For example, if coins are determined to be unsuitable for withdrawal due to soiling or wear, or if the money-type recycling storage compartments 36A is full for each money type, the coins are stored in the batch storage cassette 36C in a mixed money type. The batch storage cassette 36C is removable. The housing of the coin transaction device 30 is equipped with a cover for the batch storage cassette 36C. The cover is normally locked. For example, an attendant with the prescribed authority can unlock and open the cover, remove the batch storage cassette 36C from the housing of the coin transaction device 30, and manually collect the coins in the batch storage cassette 36C.

In the collection section 38, for example, coins and other items that a user forgets to take from the coin deposit and withdrawal port 31 when making a withdrawal are collected. The enclosure of the coin transaction device 30 is equipped with a cover for the collection section 38. The cover is normally locked. For example, an attendant with the prescribed authority can unlock the cover, open it, and manually collect the coins in the collection section 38.

### Configuration of the Money Handling System

An example of the configuration of a money handling system 70 is illustrated in FIG. 5. Money handling system 70 includes with a money handling device 1, which is operated by the customer, and a reception device 3. Reception device 3 accepts the customer's input of the details of the monetary transaction.

The money handling device 1 is equipped with a first controller 1A, an acquisition device 1B, an operation reception device 1C, a person identification device 1D, and a matching device 1E. A second controller 3A is provided in the reception device 3. In an exemplary implementation, first controller 1A, acquisition device 1B, operation reception device 1C, person identification device 1D, matching device 1E and second controller 3A are processing circuitry. The functionality of each as disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The first controller 1A controls processing related to money transaction processing (deposit, withdrawal, currency exchange, account transfer, etc.) based on transaction information.

The acquisition device 1B acquires transaction information indicating the details of the monetary transaction from the reception device 3. For this purpose, the acquisition device 1B may be configured to include a communication module capable of local area network (LAN) communication, etc.

The operation reception device 1C includes the operation panel 41 shown in FIG. 2 and accepts operations by customers, attendants, and others. The operation reception device 1C may be configured to include, in addition to or instead of the operation panel 41, a bar code reader or 2-D code reader, for example.

Bar code readers and 2D code readers may be retrofittable to existing money handling devices 1. In this case, the existing firmware and software of the money handling device 1 will be updated to support the functions of the operation reception device 1C. This eliminates the need for banks and other institutions to replace the money handling device 1.

Person identification device ID is at least one of the following: a sensor for biometric authentication by, for example, face or fingerprint recognition; a reader for property authentication by an account passbook, cash card, or official identification card (e.g., driver's license or passport); and an input device for knowledge authentication by a PIN number or telephone number. That is, the person identification device 1D obtains information (second person information) that identifies the person operating the operation reception device 1C of the money handling device 1.

The person identification device 1D may be a retrofittable configuration for existing money handling devices 1. In this case, the existing firmware and software of the money handling device 1 will be updated to support the functionality of the person identification device 1D.

The matching device 1E matches the customer information (first person information) associated with the transaction information with the information identifying the person operating the money handling device 1 (second person information).

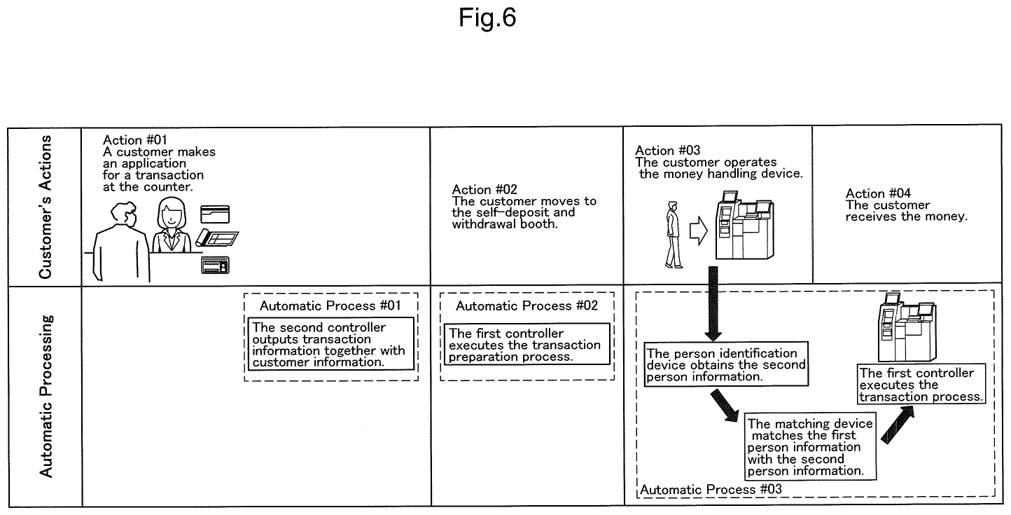

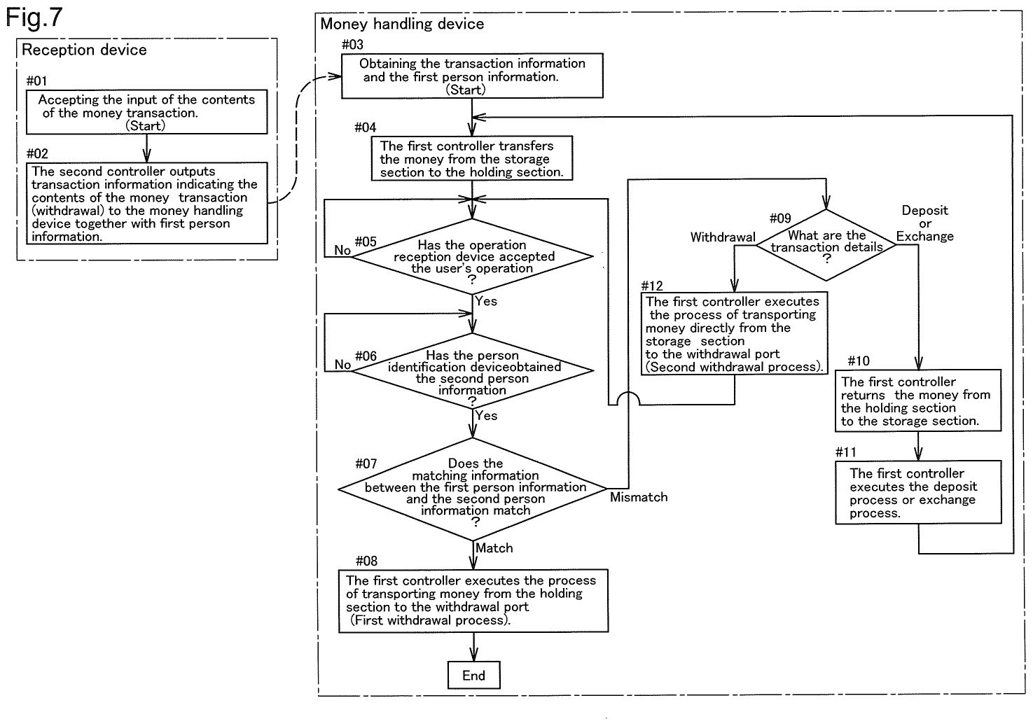

FIG. 6 shows the customer's actions and the automatic processing by the receptionist 3 and the money handling device 1 in chronological order. FIG. 7 also shows a flowchart of automatic processing by the receptionist 3 and the money handling device 1. In FIG. 7, the case where the monetary transaction is a withdrawal is shown.

As shown in “Action #01” in FIG. 6, the customer first makes an application for a transaction while interacting with a teller or other person at counter A. The teller enters the details of the monetary transaction applied for by the customer into the reception device 3. Then, “Automatic Process #01” and “Automatic Process #02” are initiated.

The automatic process #01 shown in FIG. 6 is step #01 and step #02 shown in FIG. 7.

In response to the reception device 3 accepting the input of the contents of the money transaction (step #01 in FIG. 7), the second controller 3A outputs transaction information indicating the contents of the money transaction to the money handling device 1, together with customer information (step #02 in FIG. 7).

As shown in FIG. 1, a self-deposit and withdrawal booth D is equipped with multiple money handling devices 1.

The receptionist 3 outputs the transaction information to one of the multiple money handling devices 1. At this time, the receptionist 3 may be configured to select a money handling device 1 based on the usage status (available devices), money availability status (presence or absence of desired money types), etc., and output transaction information to the selected money handling device 1.

Here, customer information is information that identifies a customer for a monetary transaction whose input is accepted by the reception device 3. The customer information output by the receptionist 3 to the money handling device 1 is referred to as ‘first person information. The transaction and customer information output by the second controller 3A is received by the acquisition device 1B in the money handling device 1.

After completing the transaction application at counter A, the customer moves from counter A to self-deposit and withdrawal booth D (action #02 in FIG. 6). As shown in FIG. 1, a self-deposit and withdrawal booth D is equipped with multiple money handling devices 1. For this reason, for example, at least one of the reception device 3 and the money handling device 1 may be equipped with a reporting device. The reporting section identifies and reports the money handling device 1 that obtained the transaction information among the plurality of money handling devices 1. The reception device informs the customer, for example, “Please come to processing machine No. 1,” using at least one visual and one auditory information. For this purpose, the notification section consists of at least one of, for example, an audio guidance speaker, a buzzer, a display (screen display, 7SEG display, etc.), etc.

While the customer is moving, first controller 1A executes the transaction preparation process to prepare money for a monetary transaction as automatic process #02.

Automatic process #02 shown in FIG. 6 is step #03 and step #04 shown in FIG. 7.

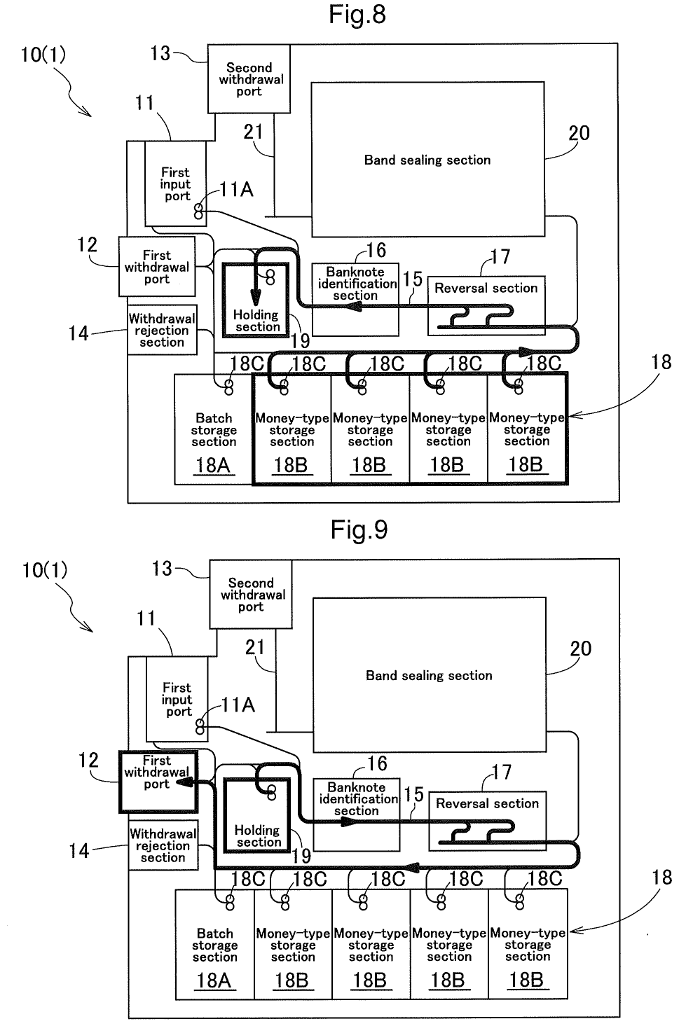

In response to obtaining the transaction information and the first person information output by the reception device 3 (step #03 in FIG. 7), the first controller 1A transfers the money from the money-type storage section 18B to the holding section 19 (step #04 in FIG. 7), as shown in FIG. 8. The processing of first controller 1A in step #04 is referred to as the ‘Withdrawal Preparation Process’. In other words, first controller 1A executes a withdrawal preparation process that transfers money from the money-type storage section 18B to the holding section 19 as a transaction preparation process.

If the money handling device 1 is executing other transaction processing at the timing when the first controller 1A acquires the transaction information and the first person information (timing of step #03 in FIG. 7), the first controller 1A executes the withdrawal preparation process (transaction preparation process) after completing the other transaction processing.

When the customer arrives at the self-deposit and withdrawal booth D, the customer operates the operation reception device 1C of the money handling device 1 (action #03 in FIG. 6). Automatic Processing #03″ by the money handling device 1 is initiated in response to the customer's operation of the operation reception device 1C of the money handling device 1. Automatic process #03 shown in FIG. 6 is step #05 through step #08 shown in FIG. 7

After completing the transaction preparation process shown in automatic process #02 in FIG. 6 and step #04 in FIG. 7 (withdrawal preparation process illustrated in FIG. 7), the money handling device 1 determines whether the operation reception device 1C has accepted the user's operation (step #05 in FIG. 7). The operation to the operation reception device 1C may be, for example, the customer's operation of deposits and withdrawals at the operation panel 41. The customer may also receive a transaction slip with a 2D code (e.g., QR code (registered trademark) or data matrix) from a teller or other person at counter A and hold the 2D code over the reader as an operation to operation reception device 1C. If the operation reception device 1C does not accept the user's operation (step #05: No in FIG. 7), the decision of step #05 is repeated, and the money handling device 1 waits for the operation of the operation reception device 1C by the user.

Once the operation reception device 1C accepts the user's operation (step #05 in FIG. 7: Yes), it is determined whether the person identification device 1D has obtained the second person information (step #06 in FIG. 7).

Specifically, it is determined whether or not the person identification device 1D has obtained at least one piece of information, such as biometric information, possession information, or PIN, about the person operating the operation reception device 1C of the money handling device 1. If the person identification device 1D has not completed obtaining the information (step #06: No in FIG. 7), the decision in step #06 is repeated and the money handling device 1 waits for the completion of identification of the person in question. Information about the person operating the money handling device 1 is referred to as “second person information.

Once the person identification device 1D completes obtaining the second person information (step #06 in FIG. 7: Yes), the matching device 1E matches the customer information (first person information) associated with the transaction information with the information identifying the person operating the money handling device 1 (second person information). If, as a result of matching, the matching information between the first person information and the second person information matches (i.e., the person who offered the transaction at counter A and the person who operates the transaction at the money handling device 1 match) (step #07 in FIG. 7: match), the money handling device 1 executes the transaction processing. Specifically, as shown in step #08 of FIG. 7, the first controller 1A of the money handling device 1 executes the process of transporting money from the holding section 19 to the first withdrawal port 12 (first withdrawal process) as shown in FIG. 9 as a transaction process when the matching device 1E determines that the first and second person information are identical. The customer then receives the money from the first withdrawal port 12, as shown in “Action #04” in FIG. 6.

Thus, the first controller 1A of the money handling device 1 executes transaction processing based on transaction information using the money prepared in the transaction preparation process in response to the customer's operation of the money handling device 1. After the transaction processing is completed, the money handling device 1 may be configured to erase the transaction information obtained from the reception device 3, or it may be configured to add completion information to the transaction information obtained from the reception device 3.

Next, the case in which the customer information (first person information) associated with the transaction information and the information about the person operating the money handling device 1 (second person information) do not match (step #07 in FIG. 7: mismatch) is explained. For example, another user who comes to the store may go directly to the self-deposit/withdrawal booth D to operate the money handling device 1 without making an application at the counter A.

If, as a result of the matching, the customer information (first person information) associated with the transaction information and the information on the person operating the money handling device 1 (second person information) do not match (step #07 in FIG. 7: mismatch), the money handling device 1 does not perform the transaction processing shown in step #08 in FIG. 7 and performs the processing described in step #09 and subsequent steps step #09 and thereafter, as described below. That is, the first controller 1A of the money handling device 1 is configured to execute the relevant first withdrawal process when the matching device 1E determines that the first and second person information match, and not to execute the relevant first withdrawal process when the matching device 1E determines that the first and second person information do not match.

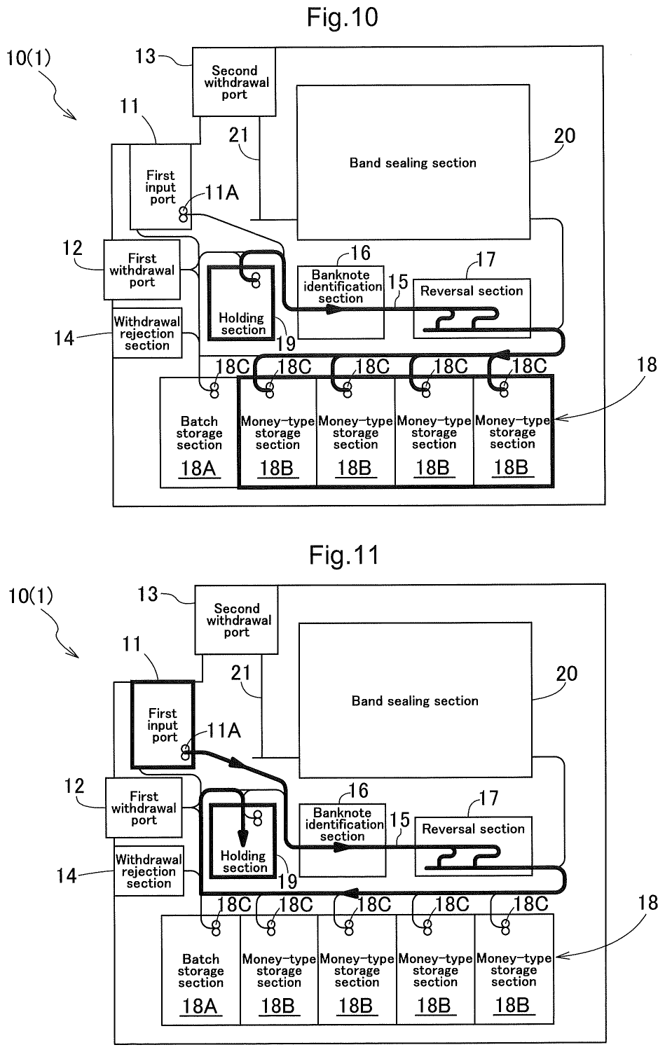

If the first person information and the second person information do not match (step #07 in FIG. 7: mismatch), the first controller 1A determines what the transaction details are (step #09). If the transaction is a deposit or exchange (step #09: deposit or exchange), it is necessary to empty the holding section 19 because it is necessary to once accept the money fed into the first input port 11 into the holding section 19. Therefore, first controller 1A executes a process (deposit preparation process) to transport the money stored in the holding section 19 to the money-type storage section 18B (step #10), as shown in FIG. 10.

The first controller 1A then executes the deposit or exchange process (step #11).

If the holding section 19 is configured to load and unload money using the FIFO method (first-in, first-out), the deposit preparation process shown in step #10 of FIG. 7 is always necessary. If the holding section 19 is a LIFO system (last in, first out, e.g., tape-rolled) and there is no capacity to store additional money in the holding section 19, the deposit preparation process shown in step #10 of FIG. 7 is necessary.

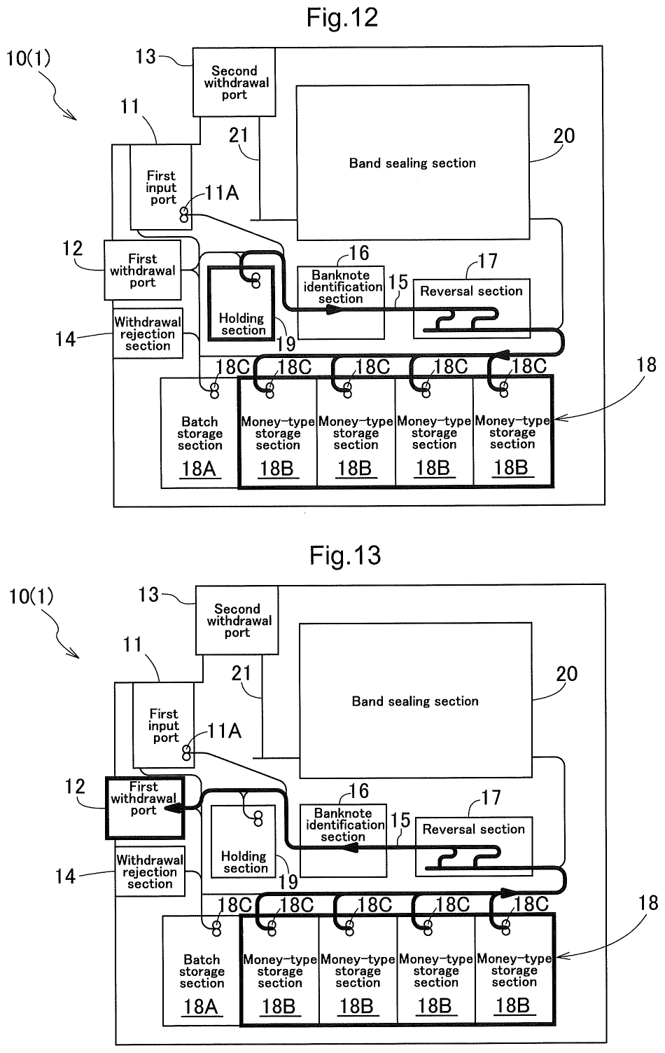

FIGS. 11 and 12 show the flow of money through the deposit process. As shown in FIG. 11, the first controller 1A executes the process of transporting money fed into the first slot 11 to the holding section 19 as a deposit process. Then, as shown in FIG. 12, first controller 1A transfers the banknotes temporarily stored in the holding section 19 to the money-type storage section 18B for each money type as a deposit process.

That is, the first controller 1A of the money handling device 1 is configured to execute the deposit preparation process in which money stored in the holding section 19 are transferred to the money-type storage section 18B in response to money being fed into the first input port 11 after the withdrawal preparation process (step #04 in FIG. 7) is executed and before the first withdrawal process (step #08 in FIG. 7) is executed. is configured to be executed.

When the deposit or exchange process based on steps #10 and #11 in FIG. 7 is completed, the process returns to step #04 and the withdrawal preparation process is executed again. Then, step #05 and subsequent steps are executed.

If the transaction is a withdrawal (step #09: Withdrawal), first controller 1A performs a process (step #12) to transport the money from the money-type storage section 18B to the first withdrawal port 12, as shown in FIG. 13. At this time, the holding section 19 already contains the money for the first withdrawal process. In the second withdrawal process, first controller 1A transfers money directly from money-type storage section 18B to first withdrawal port 12 without going through the holding section 19.

That is, the first controller 1A of the money handling device 1 is configured to execute the second withdrawal process by transferring money from the money-type storage section 18B to the first withdrawal port 12 without passing through the holding section 19 in response to the matching device 1E determining that the first and second person information do not match and the money handling device 1 has received a withdrawal operation different from the money transaction received from the reception device 3. The second withdrawal process is configured to transfer the money from the money-type storage section 18B to the first withdrawal port 12 without passing through the holding section 19.

Once the second withdrawal process based on step #12 in FIG. 7 is completed, the process from step #05 onward is executed again.

The money handling system 70 of the present disclosure includes a money handling device 1, which is equipped with a first controller 1A and operated by a customer, and a reception device 3, which is equipped with a second controller 3A and receives input of the contents of a money transaction from the customer, the second controller 3A of the reception device 3 outputting transaction information indicating the contents of the money transaction in response to receiving the input, The first controller 1A of the money handling device 1 executes a transaction preparation process to prepare money for a money transaction in response to obtaining the transaction information output by the reception device 3, and executes a transaction process based on the transaction information using the money prepared in the transaction preparation process in response to the money handling device 1 being operated by a customer.

With the above configuration, when the reception device 3 accepts information on a money transaction, the money handling device 1 can obtain transaction information indicating the details of the money transaction. The money handling device 1 then executes the transaction preparation process in response to obtaining the transaction information, allowing the customer to prepare the money in advance before operating the money handling device 1. This reduces the customer's waiting time after the customer starts operating the money handling device 1, allowing the customer to proceed smoothly with the transaction at the money handling device 1.

In the money handling system 70 of the present disclosure, the reception device 3 is a terminal device operated by the teller.

With the above configuration, the terminal device can output transaction information to the money handling device 1 based on the teller's procedures with the customer at counter A. The teller can also operate the terminal device to output transaction information and account for the customer's account.

In the money handling system 70 of the present disclosure, the money handling device 1 is provided with a storage section 18 for storing money, a first withdrawal port 12 for customers to receive money, and a holding section 19 for temporarily storing money, and the first controller 1A of the money handling device 1 performs, as a transaction preparation process, a withdrawal preparation process to transfer money from the storage section 18 to the holding section 19. The first controller 1A of the money handling device 1 executes a withdrawal preparation process to transfer money from the storage section 18 to the holding section 19 as a transaction preparation process.

With the above configuration, money for a money transaction are transferred to the holding section 19 before the customer operates the money handling device 1. This reduces the customer's waiting time after the customer begins operating the money handling device 1.

In the money handling system 70 of the present disclosure, the second controller 3A of the reception device 3 is configured to output first person information identifying a customer together with transaction information, the person identification device 1D to obtain second person information identifying a person operating the money handling device 1, and the matching device 1E to match the first person information with the second person information. The first controller 1A of the money handling device 1 executes the first withdrawal process when the matching device 1E determines that the first person information and the second person information match, and executes the first withdrawal process when the matching device 1E determines that the first person information and the second person information do not match. When the matching device 1E determines that the first person information and the second person information do not match, the first withdrawal process is not performed.

With the above configuration, the transaction process is executed only when the first person information and the second person information match. This increases the security of the transaction. It also further increases the deterrence against unauthorized use of the money handling device 1.

In the money handling system 70 of the present disclosure, the money handling device 1 is provided with a first input port 11 for customers to insert money, and the first controller 1A of the money handling device 1 is configured to, in response to money being inserted into the first input port 11 after the withdrawal preparation process is executed and before the first withdrawal process is executed, The first controller 1A is configured to execute a deposit preparation process in which money stored in the holding section 19 are transferred to the storage section 18.

With the above configuration, it is possible to empty the holding section 19 even if another customer or person performs a deposit or exchange operation at the money handling device 1. This enables the money handling device 1 to perform deposit and exchange processing based on such deposit operations, etc.

In the money handling system 70 of the present disclosure, the first controller 1A of the money handling device 1 is configured to perform the second withdrawal process by transferring money from the storage section 18 to the first withdrawal port 12 without passing through the holding section 19 in response to the matching device 1E determining that the first and second person information do not match and the money handling device 1 has accepted a withdrawal operation different from a money transaction. The second withdrawal process is configured to transfer the money from the storage section 18 to the withdrawal port 12 without passing through the holding section 19.

With the above configuration, even if another customer or person performs a withdrawal operation at the money handling device 1, the money handling device 1 can process the deposit or exchange based on the withdrawal operation, etc.

The money handling system 70 of the present disclosure is provided with a plurality of money handling devices 1 and a reporting device that identifies and reports the money handling device 1 that obtained the transaction information from the reception device 3.

With the above configuration, the receptionist 3 can select a money handling device 1 from among multiple money handling devices 1 based on the usage status (available devices), money availability status (presence or absence of desired money types), etc., and output transaction information to the selected money handling device 1. The reporting device also identifies and reports the money handling device 1 to be operated. This configuration allows the customer to precisely operate the target money handling device 1 out of multiple money handling devices 1 without accidentally selecting the wrong one.

The money handling device 1 of the present disclosure is configured to communicate with a reception device 3 that accepts the customer's input of the contents of a money transaction, and is provided with a first controller 1A and operated by the customer, wherein the first controller 1A, in response to obtaining transaction information indicating the contents of the money transaction output by the reception device 3 The first controller 1A executes a transaction preparation process to prepare money for a money transaction, and in response to receiving an operation from a customer, executes a transaction processing based on the transaction information using the money prepared in the transaction preparation process.

With the above configuration, when the reception device 3 accepts information on a money transaction, the money handling device 1 can obtain transaction information indicating the details of the money transaction. The money handling device 1 then executes the transaction preparation process in response to obtaining the transaction information, allowing the customer to prepare the money in advance before operating the money handling device 1. This reduces the customer's waiting time after the customer starts operating the money handling device 1, allowing the customer to proceed smoothly with the transaction at the money handling device 1.

In the money handling device 1 of the present disclosure, the first controller 1A is configured to execute transaction processing when the first person information identifying the customer and the second person information identifying the person operating the money handling device 1 match, and not to execute transaction processing when the first person information and the second person information do not match.

With the above configuration, the transaction process is executed only when the first person information and the second person information match. This increases the security of the transaction. It also further increases the deterrence against unauthorized use of the money handling device 1.

### Other Forms of Implementation

The present disclosure is not limited to the configuration illustrated in the embodiments described above, and other representative embodiments of the present disclosure is illustrated below.

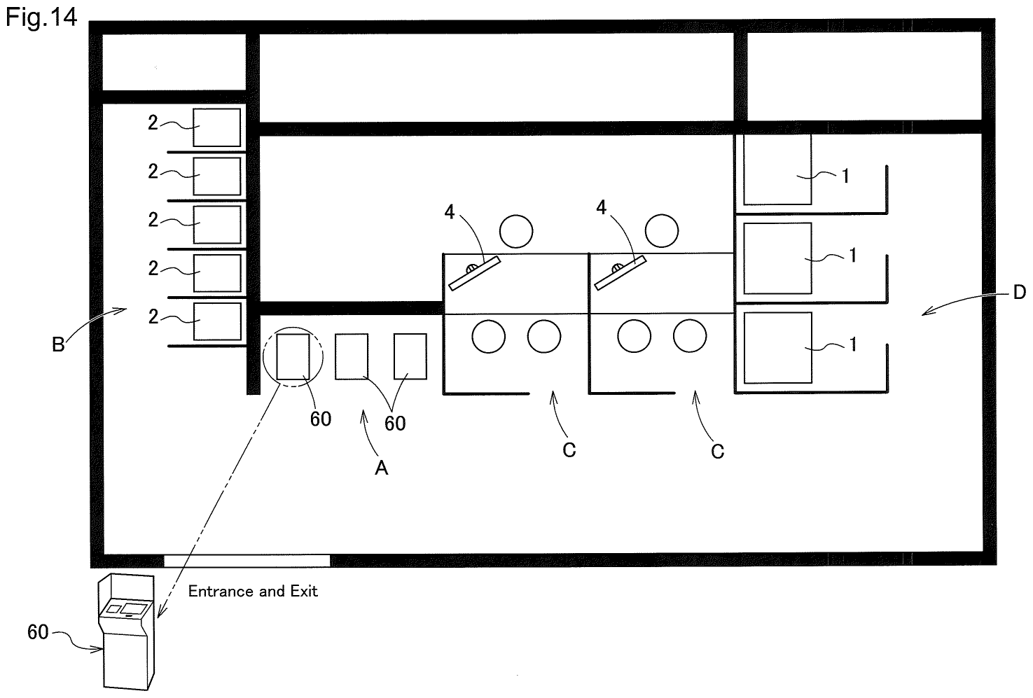

(1) In the embodiments described above, a teller (staff member) in charge of processing account transactions is stationed at counter A, and a reception device 3 is located at counter A. Not limited to these embodiments, as shown in FIG. 14, for example, an automatic reception device 60 may be placed in place of the reception device 3 at the counter A near the entrance and exit of a financial store. In other words, the reception device 3 may be a terminal device operated by the customer.

The automatic receptionist 60 is equipped with a touch panel display for operation. The automatic teller machine 60 accepts the customer's purpose of visit (deposit, withdrawal, currency exchange, account transfer, etc.) by selecting a list or inputting by hand, etc. Furthermore, it displays a slip corresponding to the accepted purpose on the display and accepts corresponding input for each item (amount, money type, etc.) of the slip. The automatic teller machine 60 is equipped with a device for reading passbooks and cash cards and a PIN input device.

The 60 automatic reception devices are also equipped with a function to issue transaction slips. The transaction slip contains, for example, a bar code or two-dimensional code (e.g., QR code (registered trademark) or data matrix). The controller of the automatic teller 60 issues the transaction slip and outputs transaction information indicating the details of the money transaction together with customer information to the money handling device 1 to be operated. Furthermore, the controller of the automatic receptionist 60 informs the customer of the money handling device 1 to be operated by at least one of a display and voice guidance. The customer then holds the transaction slip over the reader of the money handling device 1, and the transaction is processed by the money handling device 1. Any of the reception device 3 shown in FIG. 1 and the automatic reception device 60 shown in FIG. 14 may be a tablet computer, for example.

(2) In the embodiments described above, the transaction preparation process (withdrawal preparation process) and transaction processing (deposit and withdrawal processes) are based on the banknote transaction device 10 shown in FIGS. 8 through 13. The transaction preparation process of the present disclosure is also applicable to the coin transaction device 30 shown in FIG. 4. When a withdrawal process is performed, coins are ejected from the money-type recycling storage compartments 36A and transported to the coin feeder 32 via the withdrawal transport path 37. Thus, for example, as a transaction preparation process (withdrawal preparation process), the first controller 1A may be configured to transport coins from the money-type recycling storage compartments 36A to the coin feeder 32 (corresponding to step #04 in FIG. 7) in response to obtaining transaction information output by the reception device 3. The first controller 1A may then be configured to transport the coins prepared in the coin feeder 32 in the transaction preparation process through the coin identification section 34 and the coin sorting section 35 to the coin deposit and withdrawal port 31 (corresponding to step #08 in FIG. 7) in response to receiving an operation from the customer.

(3) In the embodiments described above, one holding section 19 is provided in the banknote transaction device 10. Not limited to these embodiments, the banknote transaction device 10 may be configured with a plurality of holding sections 19, one for deposits and one for withdrawals. This configuration eliminates the need for the process shown in step #10 of FIG. 7 and FIG. 10 to return the money stored in the holding section 19 to the money-type storage section 18B. For example, if the customer's transaction is to exchange money, the first controller 1A should execute the exchange preparation process to transfer the money for exchange from the storage section 18 to the holding section 19 for withdrawal as a transaction preparation process. The first controller 1A can then execute a currency exchange process that transports the banknotes stored in the holding section 19 for withdrawals to the first withdrawal slot 12 after storing the money fed into the first input port 11 in the holding section 19 for deposits.

(4) The configuration is not limited to direct communication between the reception device 3 and the money handling device 1, as shown in FIG. 5 above. For example, the communication between the reception device 3 and the money handling device 1 may be configured to go through a server (e.g., a server in a financial store, a server in an account system, etc.).

(5) If the holding section 19 is a tape-wrapped system, the holding section 19 inserts and withdraws money in a LIFO (last in, first out) system. In this configuration, the first controller 1A can be configured to additionally wind money fed into the first input port 11 onto the tape in the holding section 19 in response to money being fed into the first input port 11 before the first withdrawal process is executed.

In this configuration, if there is enough tape winding capacity in the holding section 19, the process of returning the money stored in the holding section 19 to the money-type storage section 18B, as shown in step #10 of FIG. 7 and FIG. 10, is no longer necessary. If there is room in the winding capacity of the tape in the holding section 19 and additional money fed into the first input port 11 are wound onto the tape in the holding section 19, the first controller 1A first executes the deposit process to transport the additional money wound onto the tape to the money-type storage section 18B, etc., and then the initially scheduled withdrawal process is After that, the initially scheduled withdrawal process is executed. Alternatively, if the deposit process is aborted after additional deposit money are wound onto the tape, first controller 1A can transport the additional deposit money wound onto the tape to the first withdrawal 12 first, and then perform the originally scheduled withdrawal process after the user receives the money from the first withdrawal port 12.

(6) In the embodiments described above, the first controller 1A of the money handling device 1 executes a withdrawal preparation process in which money are transferred from the storage section 18 to the holding section 19 as a transaction preparation process. Not limited to these embodiments, the first controller 1A may be configured to execute a process to transfer money from the storage section 18 to the holding section 19 and further to execute a process to transfer money from the holding section 19 to the first withdrawal port 12 as a transaction preparation process (withdrawal preparation process). In other words, the system may be configured so that money for withdrawal or exchange are accumulated at the first withdrawal port 12 during the transaction preparation process (withdrawal preparation process). The first controller 1A may then be configured to execute the process of opening the shutter of the first withdrawal port 12 as the first withdrawal process described above. This further reduces the time required for transaction processing.

(7) The first controller 1A of the money handling device 1 may be configured so that if the matching device 1E determines that the first person information and the second person information do not match, it does not perform transaction processing for the person who is determined to be the mismatch. In this case, the first controller 1A of the money handling device 1 may be configured to execute transaction processing only when the matching device 1E determines that the first and second person information match. The reporting device may be provided in the money handling device 1, and the reporting device of the money handling device 1 may be configured to call the customer for the transaction information in question. One of the multiple money handling devices 1 obtains the transaction information from the reception device 3, and the money handling device 1 that obtained the transaction information becomes the money handling device 1 to be operated. The customer is supposed to operate the relevant money handling device 1, but it is conceivable that the customer may mistakenly operate another money handling device 1. In this case, the reporting device may be configured to inform the customer to operate the money handling device 1 subject to such operation. The notification section may also be an application installed on a smartphone carried by the customer. The notification section may consist of a smartphone screen or speaker that guides the user to which one of the money handling devices 1 is the target of the operation.

(8) In the above embodiments, a financial store is equipped with multiple money handling devices 1, but a financial store may be equipped with a single money handling device 1.

The configuration disclosed in the above embodiments may be applied in combination with the configuration disclosed in other embodiments, as long as no contradiction arises.

The embodiments disclosed herein are examples, and the embodiments of the present disclosure are not limited thereto, and may be modified as appropriate to the extent not to depart from the purpose of the present disclosure.

1. A money handling system, comprising:
a money handling device operated by a customer, the money handling device including first control circuitry; and
a reception device which accepts input of information about a monetary transaction of the customer, the reception device including second control circuitry, wherein
the second control circuitry is configured to output transaction information in response to accepting the input,
the first control circuitry is configured to execute, in response to obtaining the transaction information output by the reception device, a transaction preparation process to prepare money for the monetary transaction, and
the first control circuitry is configured to execute, in response to accepting an operation by the customer, a transaction process based on the transaction information by using the money prepared in the transaction preparation process.

2. The money handling system according to claim 1, wherein the reception device is a terminal device operated by a teller.

3. The money handling system as claimed in claim 1, wherein the reception device is a terminal device operated by the customer.

4. The money handling system of claim 1, wherein
the money handling device includes:
a storage compartment for storing money,
a withdrawal port to output money to customers, and
a holding compartment for temporary storage of money, and
the first control circuitry is configured to execute a withdrawal preparation process that transfers the money from the storage compartment to the holding compartment as the transaction preparation process.

5. The money handling system of claim 4, wherein
the second control circuitry is configured to output first person information, identifying the customer together with the transaction information, to the money handling device,
the money handling device includes first circuitry configured to obtain second person information that identifies a person operating the money handling device, and match the first person information with the second person information,
the transaction process includes a first withdrawal process that transfers the money from the holding compartment to the withdrawal port, and
the first control circuitry is configured to
execute the first withdrawal process when the first circuitry determines that the first person information and the second person information match, and
not execute the first withdrawal process when the first circuitry determines that the first person information and the second person information do not match.

6. The money handling system of claim 5, wherein
the money handling device includes a deposit port through which the customer inserts money, and
the first control circuitry is configured to execute a deposit preparation process, to transfer the money stored in the holding compartment to the storage compartment, in response to money being fed into the deposit port after the withdrawal preparation process is executed and before the first withdrawal process is executed.

7. The money handling system of claim 5, wherein
the first control circuitry is configured to execute a second withdrawal process, in which money is transferred from the storage compartment to the withdrawal port without passing through the holding compartment, in response to the first circuitry determining that the first person information and the second person information do not match and the money handling device has accepted a withdrawal operation different from the money transaction.

8. The money handling system of claim 1, further comprising:
a plurality of the money handling devices including the money handling device, and
a reporting device that identifies and reports the money handling device that obtained the transaction information.

9. A money handling device, comprising:
control circuitry configured to
receive an input operation from a customer;
receive transaction information from a reception device, the transaction information including information about a monetary transaction of a customer;
execute, in response to receiving the transaction information, a transaction preparation process to prepare money for the monetary transaction; and
execute, in response to accepting an operation by the customer, a transaction process based on the transaction information by using the money prepared in the transaction preparation process.

10. The money handling device of claim 9, wherein the control circuitry is configured to
receive first person information from the reception device, the first person information identifying the customer together with the transaction information,
obtain second person information that identifies a person operating the money handling device, and match the first person information with the second person information,
execute the transaction process when the first person information the second person information match, and
not execute the transaction processing when the first person information and the second person information do not match.

11. The money handling device of claim 9, wherein the reception device is a terminal device operated by a teller.

12. The money handling device of claim 9, wherein the reception device is a terminal device operated by the customer.

13. The money handling device of claim 9, further comprising:
a storage compartment for storing money;
a withdrawal port to output money to customers; and
a holding compartment for temporary storage of money, wherein
the first control circuitry is further configured to execute a withdrawal preparation process that transfers the money from the storage compartment to the holding compartment as the transaction preparation process.

14. The money handling device of claim 13, wherein
the transaction process includes a first withdrawal process that transfers the money from the holding compartment to the withdrawal port, and
the control circuitry is configured to
execute the first withdrawal process when the first person information and the second person information match, and
not to execute the first withdrawal process when the first person information and the second person information do not match.

15. The money handling device of claim 14, further comprising:
a deposit port through which the customer inserts money, wherein
the control circuitry is further configured to execute a deposit preparation process, to transfer the money stored in the holding compartment to the storage compartment, in response to money being fed into the deposit port after the withdrawal preparation process is executed and before the first withdrawal process is executed.

16. The money handling device of claim 14, wherein the control circuitry is further configured to execute a second withdrawal process, in which money is transferred from the storage compartment to the withdrawal port without passing through the holding compartment, when the first person information and the second person information do not match and the money handling device has accepted a withdrawal operation different from the money transaction.

17. A money handling method, comprising:
receiving, by a money handling apparatus, an input operation from a customer;
receiving transaction information from a reception device, the transaction information including information about a monetary transaction of a customer;
executing, by circuitry of the money handling apparatus and in response to receiving the transaction information, a transaction preparation process to prepare money for the monetary transaction; and
executing, by the circuitry and in response to accepting an operation by the customer, a transaction process based on the transaction information by using the money prepared in the transaction preparation process.

18. The money handling method of claim 17, further comprising:
receiving first person information from the reception device, the first person information identifying the customer together with the transaction information;
obtaining second person information that identifies a person operating the money handling device, and matching the first person information with the second person information;
executing the transaction process when the first person information the second person information match; and
not executing the transaction processing when the first person information and the second person information do not match.
